(19) United States
(12) Patent Application Publication
(10) Pub. No.: US 2016/0264900 A1
(43) Pub. Date: Sep. 15, 2016

(54) MODIFIED HYDROCARBONS

(71) Applicant: SOLVAY SPECIALTY POLYMERS ITALY S.P.A., Bollate (IT)

(72) Inventors: Marco AVATANEO, Senago (IT); Claudio Adolfo Pietro TONELLI, Paderno D'adda (IT); Evgeny DENISOV, Milano (IT); Giuseppe MARCHIONNI, Milano (IT)

(21) Appl. No.: 15/034,602

(22) PCT Filed: Oct. 30, 2014
(86) PCT No.: PCT/EP2014/073299

§ 371 Date: May 5, 2016

(30) Foreign Application Priority Data
Nov. 5, 2013 (EP) 13191617.3

(51) Int. Cl. C10M 107/38; C10M 101/02; C08F 255/00

(52) U.S. Cl. CPC C10M 107/38; C08F 255/00; C10M 101/02; C10M 2213/023; C10M 2211/0206

(57) ABSTRACT

The present invention relates to branched saturated hydrocarbons which are covalently modified with haloalkylene units. Said modified hydrocarbons show low values of wear and friction with respect to the corresponding non modified hydrocarbons and can be conveniently used as lubricants in applications wherein higher resistance to wear and friction is required.

### CROSS-REFERENCE TO RELATED APPLICATIONS

This application claims priority to European patent application No. 13191617.3, filed on Nov. 5, 2013. The whole content of this application is incorporated herein by reference for all purposes.

### TECHNICAL FIELD

The present invention relates to modified hydrocarbons, in particular to modified hydrocarbons which are suitable as lubricants.

### BACKGROUND ART

It is known that certain hydrogen-based lubricants of natural or synthetic origin, in particular certain lubricant oils, are endowed with remarkable lubricant properties and are available on the market at reasonable costs. Examples of hydrogen-based lubricant oils comprise mineral oils of hydrocarbon type, animal and vegetal hydrogenated oils, synthetic hydrogenated oils including polyalphaolefins (PAOs), dibasic acid esters, polyol esters, phosphate esters, polyesters, alkylated naphthalenes, polyphenyl ethers, polybutenes, multiply-alkylated cyclopentanes, silane hydrocarbons, siloxanes and polyalkylene glycols.

Such oils are able to form an even, cohesive film on the substrate to be lubrified; cohesiveness is a desirable key property in any lubricant application, especially in automotive applications. However, their resistance to wear and friction is not suitable for certain applications.

A possible alternative to hydrogen-based lubricants is represented by (per)fluoropolyether (PFPE) lubricants, i.e. lubricants comprising a perfluorooxyalkylene chain, that is to say a chain comprising recurring units having at least one ether bond and at least one fluorocarbon moiety. PFPE lubricants are endowed with high thermal and chemical resistance, so they are useful in cases of applications characterized by harsh conditions (very high temperatures, presence of oxygen, use of aggressive chemicals and radiations, etc.) and the risk of degradation of the lubricant film is high. Nevertherless, PFPE lubricants are less performing than hydrocarbon oils in terms of adhesion properties and film strength, they are expensive and also outperforming from the standpoint of thermal stability in applications wherein conditions are not harsh, i.e. wherein the lubricant temperature does not exceed 150° C.

It would therefore be desirable to provide hydrogen-based lubricants having higher resistance to wear and friction, which are suitable for applications wherein the use of PFPE lubricants is not required.

U.S. Pat. No. 2,540,088 (DU PONT) 6Feb. 1951 discloses a process for the preparation of polyfluorosaturated hydrocarbons which are said to possess extreme stability and inertness.

The process comprises the reaction of a saturated hydrocarbon compound containing aliphatic carbon (i.e. free of ethylenic and acetylenic unsaturations) (col. 1, lines 44-47) with a polyfluoroethylene containing at least three halogen atoms, in particular TFE. When TFE is used, the resulting compounds contain one or more TFE units per molecule of hydrocarbon compound and can be represented with the general formula:

H(CF₂CF₂)ₙR

where n is a positive integer in the range of 1 to about 25 and R is the complementary portion of the hydrocarbon reactant. Preferably, n is in the range 1 to 15 (col. 3, lines 65-74).

The process is usually carried out placing a given amount of saturated hydrocarbon and a polyfluoroethylene in a high pressure reaction vessel with or without catalyst and heating to the desired temperature.

The resulting compounds of formula H(CF₂CF₂)ₙR are said to have low molecular weight (col. 3, line 75 to col. 4, lines 1-2).

Example 11 of this prior art document discloses in particular the preparation of a polyfluorosaturated hydrocarbon by reaction of paraffin wax and TFE with benzoyl peroxide as catalyst. The resulting product is said to possess improved lubricating properties; however, this product is in the form of a low-melting wax and therefore it is not suitable for applications wherein products that are liquid at room temperature or below are required. Furthermore, no tribological or rheological data are reported. This document teaches that “Polymeric materials such as polyethylene and polyisoibutylene are also operable in the process . . . ” (col. 8, lines 23-25) of the invention; however, no examples on such materials are reported.

U.S. Pat. No. 2,411,159 (DU PONT) 19 Nov. 1946 discloses highly fluorinated lubricants obtained by reaction of TFE and a non-polymerizable organic compound. The lubricants have the following general formula:

X(CF₂CF₂)ₙY

in which X is a member of the group consisting of hydrogen and halogen, n is a positive integer greater than 1 and Y is the complementary portion of the organic reactant.

Among non-polymerizable organic compounds, saturated aliphatic hydrocarbons are only generically mentioned.

The lubricants are said to be applicable for use on bearing surfaces and they are said to have low viscosity.

U.S. Pat. No. 3,917,725 (PENNWALT CORP) 4 Nov. 1975 discloses a process for the insertion of hexafluoropropene (HFP) at the aliphatic carbon-hydrogen bond of a hydrocarbon in a highly controlled manner to give a 1 to 1 adduct. The process is carried out by “ . . . heating the compound containing the aliphatic carbon-hydrogen bond with hexafluoropropene in the complete absence of air or other free oxygen containing gas and in the complete absence of any chemical initiator, i.e. free radical-forming chemical catalyst” (col. 2, lines 26-30). On column 3, lines 8-12, it is stated that the insertion reaction is applicable to any hydrocarbon containing at least one aliphatic carbon-hydrogen bond and which is free of acetylenic and terminal ethylenic unsaturation, including polyolefins. At col. 5, line 57, to col. 6, line 13, it is taught that, according to the amount of inserted HFP units, the properties of the adducts vary, but there is no mention of effects on wear and friction.

Other patent documents in the name of DU PONT disclose functional compounds modified with a polyfluoroethylene, in particular with TFE.

For example, U.S. Pat. No. 2,411,158 (DU PONT) 19 Nov. 1946 relates to polyfluoro carbonyl compounds that may be obtained by reaction of a polyfluoroethylene containing at least three halogen atoms of which at least two are fluorine (preferably TFE) with a saturated organic carbonyl compound containing at least two carbon atoms and containing only carbon, hydrogen and oxygen atoms. The amount of TFE units in the compounds is preferably from 1 to 25 (see, e.g. claims 5 and 6) and it stems from the data contained in the examples that the fluorine percent content is above 45%. At col. 4, lines 26-28, it is stated that the compounds have low molecular weight. These carbonyl compounds are said to have outstanding chemical and thermal stability and can be used as lubricants (col. 10, lines 1-3).

U.S. Pat. No. 2,433,844 (DU PONT) 6 Jan. 1948 relates to saturated organic polyfluoroether compounds and to a process for their preparation. The process comprises the reaction between a polyfluoroethylene containing at least three halogen atoms of which at least two are fluorine (preferably TFE) with a saturated organic compound containing an ether linkage. When TFE is used, the number of TFE units in the compounds is from 1 to 25, preferably from 1 to 7. It appears from the examples that the fluorine content is above 40% wt. These ethers are said to be useful as solvents and reaction media.

U.S. Pat. No. 2,559,628 (DU PONT) 10 Jul. 1951 relates to fluorine-containing alcohols of formula:

H(CX₂CX₂)ₙZOH

in which the X substituents are halogen atoms having an atomic weight of less than 40 of which at least half in each CX₂CX₂ groups are fluorine atoms, n is a positive integer from 1 to 12 and ZOH is the radical of a specific non-tertiary alcohol (col. 2, lines 2-14). The alcohols have low molecular weight (col. 3, lines 24-26). It appears from the examples that the fluorine content in the compounds is higher than 45%. The compounds can be used as lubricants (col. 10, line 15) and are said to possess improved thermal and chemical stability; however, no tribological or rheological data are reported.

U.S. Pat. No. 3,835,004 (JAPAN ATOMIC ENERGY RES INST) 10 Sep. 1974 discloses a process for cross-linking an olefine polymer, said process comprising irradiating the olefin polymer with an ionizing radiation in the presence of an ethylenically unsaturated hydrocarbon, e.g. TFE, and a monomer selected from acetylene and 1,3-butadiene. In particular, Example 4 refers to the cross-linking of polypropylene pellets with a mixture of TFE and acetylene and contains a table (table 3) reporting, inter alia, a comparative example of attempted cross-linking of polypropylene pellets with TFE only wherein the amount of obtained cross-linked polymer is 0%. Olefine polymers are defined at col. 2, lines 21-36 and at lines 37-40 it is stated that the invention is applicable to such polymeric materials “ . . . in any form, that is in the form of powder, pallets, strings, plate, bars and others, or in any shaped articles, or in the foamed state”. This prior art document does not mention or teaches to carry out the process on polymeric materials in the form of oils.

### SUMMARY OF INVENTION

It has now been found that branched saturated hydrocarbons containing at least 15 carbon atoms can be covalently modified with a halogenated olefin (herein after “haloalkylene”) to obtain modified branched saturated hydrocarbons endowed with more favourable rheological and tribological properties than the corresponding unmodified hydrocarbons. In fact, such modified hydrocarbons have the same thermal stability as the corresponding unmodified hydrocarbons, but they show low values of wear and friction.

Accordingly, the present invention relates to modified branched saturated hydrocarbons, said modified hydrocarbons comprising a branched saturated hydrocarbon chain (Rₕ) containing at least 15 carbon atoms and at least one haloalkylene unit covalently bound thereto. For the purposes of the present invention, a “haloalkylene unit” is an alkylene unit containing at least one halogen atom selected from fluorine and chlorine. Preferably, the at least one haloalkylene unit is a polyaloalkylene unit, more preferably a tetrafluoroethylene (TFE) or a hexafluoropropylene (HFP) unit.

The modified hydrocarbons of the invention preferably comply with the following general formula (I):

Rₕ(CXYCXY)ₙH (I)

wherein:
Rₕ represents a branched saturated hydrocarbon chain containing at least 15 carbon atoms;
each X is independently selected from:
hydrogen and
a halogen selected from fluorine and chlorine;
   each Y is independently selected from:
hydrogen;
a halogen selected from fluorine and chlorine;
a group of formula R¹-L-, wherein R¹ is a straight or branched C₁-C₁₀ alkyl group, optionally fully or partially halogenated and optionally interrupted by one or more heteroatoms, including N, O, S and P, and —L— represents a covalent bond or a group selected from —NR²—, —O— and —S—, wherein R² is fully or partially halogenated C₁-C₃ alkyl;
n is a number equal to or higher than 1,
   with the proviso that at least one of X or Y in the —CXYCXY— unit is halogen, preferably fluorine.

For the sake of clarity, throughout the present description, chain (Rₕ) comprises only carbon and hydrogen atoms and is free from multiple bonds. In the modified hydrocarbons of the invention, only one carbon atom of chain (Rₕ) is covalently bound via a spa bond to a carbon atom of the haloalkylene unit. The expression “modified hydrocarbon” is used to distinguish the hydrocarbons of the invention from the corresponding hydrocarbons which do not contain haloalkylene units.

Preferably, (Rₕ) is a chain of a branched saturated hydrocarbon (RₕH) containing at least 15 carbon atoms, said hydrocarbon (RₕH) being preferably selected from mineral oils and polyalphaolefins (PAOs); most preferably, branched saturated hydrocarbons (Rₕ) containing at least 15 carbon atoms are PAOs. For the sake of clarity, in the present description, the expression “branched saturated hydrocarbon (RₕH) containing at least 15 carbon atoms” identifies a liquid hydrocarbon, typically in the form of an oil having a kinematic viscosity of at least 2 cSt at 100° C. and atmospheric pressure.

According to a preferred embodiment, chain (Rₕ) is a hydrocarbon chain comprising alkyl pendant groups having a number of carbon atoms higher than 3.

Preferably, group R¹ is fully or partially fluorinated or chlorinated, more preferably fluorinated.

According to a first preferred embodiment, in general formula (I) all of X and Y represent fluorine or chlorine, more preferably fluorine. The modified hydrocarbons wherein all of X and Y are fluorine comply with formula (Ia) below:

Rₕ(CF₂CF₂)ₙH (Ia)

wherein Rₕ and n are as defined above.

According to a second preferred embodiment, in general formula (I) one Y is a group of formula R¹-L- wherein R¹ is a perfluorinated straight or branched C₁-C₁₀ alkyl group and -L- represents a covalent bond, while the other Y and both X are halogen, preferably fluorine. The modified hydrocarbons according to this embodiment can be represented by formulae (Ib) and (Ib*) below:

Rₕ[CXYCX(R¹)]ₙH (Ib)

Rₕ[CX(R¹)CXY]ₙH (Ib*)

wherein Rₕ and n are as defined above, the other Y and both X are halogen and and R¹ is a perfluorinated straight or branched C₁-C₁₀ alkyl group.

More preferably, in formulae (Ib) and (Ib*) R¹ is trifluoromethyl, while the other Y and both X are fluorine.

According to a third preferred embodiment, in general formula (I) Y is a group of formula R¹-L- wherein R¹ is a perfluorinated straight or branched C₁-C₁₀ alkyl group optionally interrupted by one or more oxygen atoms, -L- represents —O—, while the other Y and both X are halogen, preferably fluorine. The modified hydrocarbons according to this embodiment can be represented by formulae (Ic) and (Ic*) below:

Rₕ[CXYCX(OR¹)]ₙH (Ic)

Rₕ[CXY(OR¹)CXY]ₙH (Ic*)

wherein Rₕ and n are as defined above, X and Y are halogen and R¹ is a perfluorinated straight or branched C₁-C₁₀ alkyl group optionally interrupted by one or more oxygen atoms.

In general formula (I) and in formulae (Ia), (Ib), (Ib*), (Ic) and (Ic*), n ranges preferably from 1 to 6, more preferably from 1 to 2 (extremes included); it has indeed surprisingly been found out that, despite this low content of haloalkylene units, wear and friction are lower than that of the corresponding unmodified hydrocarbons.

The compounds according to the invention can be obtained by means of a process which comprises the radical reaction of a branched saturated hydrocarbon containing at least 15 carbon atoms [hydrocarbon (RₕH)] with a haloalkylene of formula (II)

CYX═CXY (II)

in which Y and X are as defined above.

Preferred examples of haloalkylenes suitable for carrying out the invention are polyhaloalkylenes like tetrafluoroethylene (TFE), hexafluoropropene (HFP), perfluorinated olefins of formula R¹-CF═CF₂ wherein R¹ is a perfluorinated straight or branched C₁-C₁₀ alkyl group and perfluorinated vinyl ethers of formula R¹-O—CF═CF₂ in which R¹ is a perfluorinated straight or branched C₁-C₁₀ alkyl group optionally interrupted by oxygen atoms. The polyhaloalkylene of formula (II) is preferably tetrafluoroethylene (TFE) or perfluoropropylene (PFP); more preferably, the polyhaloalkylene of formula (II) is TFE.

In a first preferred aspect, hydrocarbon (RₕH) is a mineral oil; in a second preferred aspect, hydrocarbon (RₕH) is a PAO; more preferably, hydrocarbon (RₕH) is a PAO.

Examples of PAOs suitable for carrying out the invention are those marketed as Klüberoil®, Klüber® Summit R, SpectraSyn™, Exxtral™, while suitable mineral oils are those marketed as Klüber0 Summit RHT, Yubase® 4, Kluberoil® GEM.

The radical reaction can be carried out according to known methods, for example according to the teaching of U.S. Pat. No. 2,540,088.

In greater detail, the radical reaction can be initiated by contacting hydrocarbon (RₕH) and haloalkylene (II) with organic or inorganic peroxides, with redox systems, with ozone or hydrogen peroxide; it can also be initiated by thermal or photochemical decomposition of hydrocarbon (RₕH). According to a preferred embodiment, the reaction is initiated by contacting hydrocarbon (RₕH) and haloalkylene (II) with an organic or inorganic peroxide, with a redox system, with ozone or hydrogen peroxide; most preferably the reaction is carried out by contact with an organic or inorganic peroxide. Under such conditions, the reaction has the advantage of being safer and of providing higher yields, because hydrocarbon (RₕH) does not undergo degradation.

Organic peroxides include, for example, diacyl peroxide, peroxy esters, peroxidicarbonates, dialkyl peroxides, ketone peroxides, peroxy ketals, hydroperoxides, which are soluble in hydrocarbons RₕH; more preferably, the organic peroxide is selected from benzoyl peroxide and di-ter-butyl peroxide (DTBP).

Inorganic peroxides include, for example, ammonium peroxydisulfate, potassium peroxydisulfate, sodium peroxydisulfate and potassium monopersulfate.

Examples of redox systems include those based on Fe(II) ions in combination with hydrogen peroxide, organic peroxides (including alkyl peroxides, hydroxyperoxides, acyl peroxides), peroxydisulphates, peroxydiphosphates; Cr (II), V (II), Ti (III), Co (II) and Cu (I) ions can also be employed instead of Fe(II) ions in many of these systems. Redox systems based on organic alcohols and transition metals chosen among Ce (IV), V (V), Cr (VI) and Mn (III) can also be employed.

The thermal decomposition of hydrocarbons (RₕH) can be achieved by heating a mixture of hydrocarbon (RₕH) and haloalkylene (II) at such a temperature as to generate radicals (Rₕ.); this temperature depends on the specific hydrocarbon (RₕH) to be modified and can be determined by the person skilled in the art on a case-by-case basis according to known methods. In any case, this temperature is generally higher than 150° C., typically higher than 200° C.

The photochemical decomposition of hydrocarbon (RₕH) can be accomplished by submitting a mixture of hydrocarbon (RₕH) and haloalkylene (II) to a radiation source, including UV-rays, X-rays and γ-rays sources. Photochemical decomposition by exposure to UV-rays is typically carried out in the presence of a photo-initiator, including, for example, benzoin ethers, benzyl ketals, α-dialkoxy-acetophenones, α-hydroxy-alkyl-phenones, α-amino-alkyl-phenones, acylphosphine oxides, benzophenones, benzoamines, thio-xanthones, thio-amines, titanocenes.

The process of the invention is preferably carried out without solvents;

nevertheless, solvents can also be employed, especially if hydrocarbon (RₕH) is highly viscous, in particular if viscosity is higher than 3,000 cSt, in order to bring hydrocarbon (RₕH) into intimate contact with haloalkylene (II). If a solvent is used, it will be selected by the person skilled in the art on a case-by-case basis, according to the specific hydrocarbon (RₕH) and haloalkylene (II), in such a way as it does not generate radicals that might interfere with the reaction between hydrocarbon (RₕH) and haloalkylene (II). Examples of suitable solvents are organic solvents like alkanes, ketons, esters and aromatics solvents, optionally chlorinated or fluorinated.

The reaction can be carried out under batch, semi-batch or continuous conditions. The feeding of reactants and the proceeding of the reaction is checked by sampling the reaction mixture and by determining the amount of haloalkylene units inserted in hydrocarbon (RₕH).

The reaction is generally carried out under magnetic or mechanical stirring and in the absence of oxygen.

If the radical reaction is initiated by contacting hydrocarbon (RₕH) and haloalkylene (II) with organic or inorganic peroxides, the temperature is typically set in such a way as to range from 20° C. to 250° C., preferably from 50° to 200° C. The reaction temperature will be established by the person skilled in the art on the basis of the decomposition kinetics of the peroxide. Optionally, in order to keep the concentration of radicals (Rₕ.) within a defined range over the process, the temperature can be increased, either linearly or step-by-step, with time.

If the radical reaction is initiated by contacting hydrocarbon (RₕH) and haloalkylene (II) with a redox system, it is typically performed at a temperature ranging from −40° C. to 250° C., preferably from 20° C. to 100° C.

If the radical reaction is initiated by photochemical decomposition of hydrocarbon (RₕH) with photo-initiators or by radiation-induced decomposition of hydrocarbon (RₕH), it is typically performed at a temperature ranging from −100° C. to 200° C., preferably from −40° C. to 120° C.

If the radical reaction is initiated by thermal decomposition of hydrocarbon

(RₕH), it is typically performed at a temperature ranging from 100° C. to 350° C., preferably from 150° C. to 300° C.

The reaction can be performed either in batch or in semi-batch or in a continuous stirred-tank reactor.

At the end of the reaction, the excess of haloalkylene (II), residues of any organic initiators and any undesired by-products are removed by using techniques known in the art, for example by distillation or solvent extraction. Filtration can also be carried out afterwards to remove any solid impurities. Distillation is typically carried out under reduced pressure at a temperature lower than that at which thermal decomposition of the lubricant begins. As an alternative, water-vapour phase distillation can be used. Extraction is typically carried out with halogenated solvents which solubilise the excess of residues and by-products, but not the modified hydrocarbon; among halogenated solvents, (per)fluoropolyether (PFPE) solvents are preferred.

As anticipated above, the modified hydrocarbons according to the invention are endowed with lower values of wear and friction that the corresponding non modified hydrocarbons, but they maintain the same thermal and chemical stability. Therefore, they can be conveniently used as lubricants in applications wherein higher resistance to wear and friction is required, but the conditions are not so harsh to require the use of PFPE lubricants. For example, the modified hydrocarbons according to the present invention can be used as lubricants for internal combustion engine oils (including car engines, tractor engines, gas engines, marine diesel engine), gears, ballistics systems, compressors (for example screw compressor, roots compressor, turbo compressor, compressor for the production of compressed air), refrigerators, turbines, hydroelectric plants, and wind-mills. Thus, the present invention also relates to a lubrication method comprising applying a modified hydrocarbon according to the present invention to a substrate.

Although the modified hydrocarbons are preferably used as such, they can also be mixed with further ingredients and additives to form lubricant compositions. Indeed, it has been observed that the modified hydrocarbons of the invention, especially hydrocarbons of formula (I) wherein n ranges from 1 to 2, are endowed with improved solubility properties. In fact, it has been observed that they are able to dissolve higher amounts of additives which are typically used in lubricant compositions. Thus, the present invention further comprises a method of manufacturing lubricant compositions comprising mixing the modified hydrocarbons of the invention with further ingredients and additives, as well as lubricant compositions containing one or more modified hydrocarbons according to the invention in admixture with further ingredients and additives. Examples of further ingredients are unmodified hydrocarbon oils; however, (per)fluoropolyether oils (PFPE oils) can also be used. Examples of suitable PFPE oils are those identified as compounds (1)-(8) in European patent application EP 2100909 A (SOLVAY SOLEXIS SPA) 16.09.2009. Metal detergents, ashless dispersants, oxidation inhibitors, rust inhibitors (otherwise referred to as anti-rust agents), emulsifiers, extreme pressure agents, friction modifiers, viscosity index improvers, pour point depressants and foam inhibitors can also be used as further ingredients/additives to be added to the modified lubricants of the invention to prepare lubricant compositions. Suitable further ingredients and additives and methods for the manufacture of lubricant compositions will be chosen by the person skilled in the art according to the selected modified hydrocarbon and the specific intended use, in view of the common general knowledge, for example according to Lubricants and lubrication. 2nd edition. Edited by MANG, Theo, et al. Weinheim: Wiley-VCH Verlag GmbH, 2007.

Lubricant compositions containing the modified lubricants of the invention can be, for example, in the form of oils, greases or waxes.

Should the disclosure of any patents, patent applications, and publications which are incorporated herein by reference conflict with the description of the present application to the extent that it may render a term unclear, the present description shall take precedence.

The invention will be herein after illustrated in greater detail in the following experimental section.

### EXPERIMENTAL SECTION

Materials and methods

### Materials

Polyalphaolefin 65/40 (PAO 65/40) was purchased from Klüber® Lubrication. Mineral oil Yubase®-4 was purchased from Fuchs Lubricants. Di-tert-butyl peroxide (DTBP), benzoyl peroxide (BPO), silicone oil (polydimethylsiloxane, (CH₃)₃SiO—[SiO(CH₃)₂]ₓ—OSi(CH₃)₃), phenol and tetraglyme were purchased from Sigma-Aldrich®. All reagents were used as received.

### Methods

¹⁹F-NMR spectra were recorded on a Varian Mercury® 300 MHz spectrometer using non-diluted samples.
Dynamic thermogravimetric analyses (TGA) were carried out on a Perkin Elmer® PYRIS 1 TGA apparatus.
For tribological tests, a tribometer “SRV III” (SRV stands for Schwingungs-, Reibungs- and Verschleisstest) was used.
Rheological tests were carried out on a “Dynamic mechanical spectrometer Rheometric ARES”. Geometry: Couette. Mode: Steady rate sweep test: 0°-150° C.
GPC analyses were carried out on a Waters 410 Differential Refractometer.
Solubility tests were carried out using silicon oil, phenol and tetraglyme as reference additives for lubricants.
The procedure comprised dissolving 1 g of reference additive in 2 grams of unmodified hydrocarbon or of modified hydrocarbon according to the invention, stirring for 30 minutes at room temperature, centrifuging at 4000 rpm for 30 minutes, sampling and measuring the solubility of each reference additive by ¹H NMR with hexafluoroxylene standard capillary.

### SYNTHESIS EXAMPLES

### Synthesis Example 1

### PAO Modified with Tetrafluoroethylene

30 g PAO 65/40 and 3 g DTBP (20 mmol) were placed in a 100 ml stainless steel autoclave equipped with pneumatic stirrer (300 rpm). 10 bar TFE was loaded in the autoclave. The resulting mixture was heated following this heating ramp: 120° C. for 2 hours, 130° C. for 2 hours, 140° C. for 1 hour.

At the end of the reaction the pressure in the reactor was 2.6 bar. The reaction product was recovered and distilled at atmospheric pressure at 150° C. to remove any volatile by-products. The ¹⁹F-NMR analysis indicated the presence, in the final product, of 13% by weight of TFE units with an average length of 2 carbon atoms (corresponding to 1 monomer unit).

### Synthesis Example 2

### PAO Modified with Tetrafluoroethylene

Example 1 was repeated, with the difference that the pressure in the reactor was maintained constant at 10 bars during the whole synthesis by continuous additions of TFE (necessary to compensate the pressure decrease observed due to reaction of TFE).

The reaction product was recovered and distilled at atmospheric pressure at 150° C. to remove any volatile by-products. The ¹⁹F-NMR analysis showed the presence, in the final product, of 18% by weight of TFE units with an average length of 2.3 carbon atoms (approximately 1 TFE unit).

### Synthesis example 3

### Mineral Oil Modified with Tetrafluoroethylene

60 g mineral oil (Mw=400, 150 mmol) and 2 g BPO (6 mmol) were placed in a 250 ml glass flask equipped with mechanic stirrer (400 rpm). The flask was purged with nitrogen to remove the traces of oxygen. Then 2 Nl/h of TFE was bubbled in the mineral oil at 80° C. for 17 hours (total TFE=1,150 mmol). Fresh BPO was added twice during the reaction after 4 and 11 hours [2 g BPO (6 mmol) per addition].

Thereafter, the reaction mixture was purged with nitrogen. The reaction product was recovered, centrifuged for 30 minutes at 4,000 rpm and distilled at 10⁻³ mbar pressure at 220° C. to remove any volatile by-products. The ¹⁹F-NMR analysis indicated the presence, in the final product, of 3% by weight of TFE units with an average length of 2 carbon atoms (corresponding to 1 TFE unit).

### Analyses and Tests

### Viscosity

The viscosity of the modified PAO of Example 1 is reported, in comparison with non-modified PAO 65/40, in table 1. The modification of the PAO led to a moderate increase of viscosity.

The viscosity of the modified mineral oil of Example 3 is reported in comparison with non-modified mineral oil Yubase®-4, in table 1a. Also in this case the modification of the oil led to a moderate increase of viscosity.

TABLE 1
Viscosity

| | viscosity, Pa * s | | | | |
|---|---|---|---|---|---|
| Sample | 0° C. | 30° C. | 50° C. | 100° C. | 150° C. |
| PAO 65/40 | 0.650 | 0.090 | 0.030 | 0.007 | 0.002 |
| Modified PAO | 1.924 | 0.178 | 0.060 | 0.010 | 0.003 |
| of Example 1 | | | | | |

TABLE 1a
Viscosity

| | viscosity, Pa * s | | | | |
|---|---|---|---|---|---|
| Sample | 0° C. | 10° C. | 30° C. | 40° C. | 70° C. |
| Yubase ®-4 | 0.245 | 0.109 | 0.04 | 0.027 | |
| Modified oil | 0.48 | 0.214 | 0.056 | 0.023 | 0.011 |
| of example 3 | | | | | |

### TGA Analyses

The TGA analyses on modified PAO of Example 1 and of PAO65/40, in nitrogen and in air, are reported in Tables 2 and 3 below. Thermal stability is not negatively affected by the insertion of TFE in the PAO.

TABLE 2
TGA in nitrogen

Weight loss

| | |
|---|---|
| 10% | 50% |

T (° C.)

| | | |
|---|---|---|
| PAO 65/40 | 309 | 363 |
| Modified PAO of | 309 | 367 |
| example 1 | | |

TABLE 3
TGA in air

Weight loss

| | |
|---|---|
| 10% | 50% |

T (° C.)

| | | |
|---|---|---|
| PAO 65/40 | 286 | 333 |
| Modified PAO of | 291 | 339 |
| example 1 | | |

### Tribological Tests

Tribological tests were carried out on the modified PAO of example 1 and on PAO 65/40 under isoviscous conditions and also on the mineral oil of Example 3 and on mineral oil Yubase®-4. The results are reported in Tables 4 and 4a below. The lowest values of wear and friction were measured with the modified PAO of example 1 both at high and at low loads. The modified oil of example 3 also showed reduced friction with respect to the non-modified oil.

TABLE 4
Tribological tests on modified and non-modified PAOs
under isoviscous conditions

| | | | | | | | |
|---|---|---|---|---|---|---|---|
| | | | | | Δ | | |
| | Load, | T, | Viscosity, | | COF*, | Wear, | Δ wear, |
| Sample | N | ° C. | cP | COF* | % | mm | % |

1st test

| | | | | | | | |
|---|---|---|---|---|---|---|---|
| PAO 65/40 | 300 | 50 | 29 | 0.164 | | 0.94 | |
| Modified | 300 | 65 | 29 | 0.128 | −22 | 0.52 | −45 |
| PAO of | | | | | | | |
| Example 1 | | | | | | | |

2nd test

| | | | | | | | |
|---|---|---|---|---|---|---|---|
| PAO 65/40 | 50 | 25 | 94 | 0.211 | | 0.54 | |
| Modified | 50 | 40 | 97 | 0.117 | −45 | 0.33 | −39 |
| PAO of | | | | | | | |
| Example 1 | | | | | | | |

*COF = friction coefficient

TABLE 4
Tribological tests on modified and non-modified mineral oil under
isoviscous conditions

| | Load, | | Viscosity, | | Δ COF*, | Wear, | Δ wear, |
|---|---|---|---|---|---|---|---|
| Sample | N | T, ° C. | cP | COF*,% | % | mm | % |
| Mineral | 300 | 40 | 26 | 0.172 | — | 0.87 | — |
| oil | | | | | | | |
| Yubase ® | | | | | | | |
| −4 | | | | | | | |
| Modified | 300 | 50 | 25 | 0.137 | −20 | 0.84 | −3 |
| oil of | | | | | | | |
| example | | | | | | | |
| 3 | | | | | | | |

*COF = friction coefficient

### Solubility Tests

Solubility tests were carried out as described in the section material and methods using PAO 65/40 and the modified PAO of Example 1. The results are reported in table 5 below.

TABLE 5
Solubility tests

| | Amount of | Amount of reference |
|---|---|---|
| | reference | additive dissolved in |
| | additive dissolved | the modified PAO of |
| Reference | in PAO 65/40 | example 1 |
| additive | (% by weight) | (% by weight) |
| Phenol | 1.3 | 4 |
| Silicone oil | 4 | 7 |
| Tetraglyme | 4.4 | 12.5 |

The above results show that the modified PAOs according to the present invention are able to dissolve significantly higher amounts of additives.

1. A modified branched saturated hydrocarbon, said modified hydrocarbon comprising a branched saturated hydrocarbon chain (Rₕ) containing at least 15 carbon atoms and at least one haloalkylene unit covalently bound thereto.

2. The modified branched saturated hydrocarbon according to claim 1, wherein hydrocarbon chain (Rₕ) comprises alkyl pendant groups having a number of carbon atoms higher than 3.

3. The modified hydrocarbon according to claim 1, wherein the hydrocarbon is a compound of formula (I):
Rₕ(CXYCXY)ₙH (I)
wherein:
Rₕ represents a branched saturated hydrocarbon chain containing at least 15 carbon atoms;
each X is independently selected from:
hydrogen and
a halogen selected from fluorine and chlorine;
each Y is independently selected from:
hydrogen;
a halogen selected from fluorine and chlorine;
a group of formula wherein le is a straight or branched C₁-C₁₀ alkyl group, optionally fully or partially halogenated and optionally interrupted by one or more heteroatoms including N, O, S and P and -L- represents a covalent bond or a group selected from —NR²—, —O— and —S—, wherein R² is fully or partially halogenated C₁-C₃ alkyl;
n is a number equal to or higher than 1,
with the proviso that at least one of X or Y in the -CXYCXY- unit is halogen.

4. The modified hydrocarbon according to claim 1, wherein (Rₕ) is a chain of a branched saturated hydrocarbon (RₕH) which is a mineral oil or a polyalphaolefin (PAO).

5. The modified hydrocarbon according to claim 3, wherein all -Y and -X are fluorine.

6. The modified hydrocarbon according to claim 3, or wherein one Y is a group of formula R¹-L- wherein R¹ is a perfluorinated straight or branched C₁-C₁₀ alkyl group and -L- represents a covalent bond, while the other Y and both X are halogen.

7. The modified hydrocarbon according to claim 6, wherein R¹ is trifluoromethyl and the other Y and both X are fluorine.

8. The modified hydrocarbon according to claim 3, wherein one Y is a group of formula R¹-L- wherein R¹ is a perfluorinated straight or branched C₁-C₁₀ alkyl group and -L- represents —O—, while the other Y and both X are halogen.

9. The modified hydrocarbon according to claim 7, wherein the other Y and both X are fluorine.

10. The modified hydrocarbon according to claim 3, wherein n is a number ranging from 1 to 6.

11. The modified hydrocarbon according to claim 10 wherein n is a number ranging from 1 to 2.

12. A lubrication method comprising applying a modified hydrocarbon of claim 1 to a substrate.

13. A method of manufacturing a lubricant composition comprising mixing a hydrocarbon of claim 1 with further ingredients and additives.

14. A lubricant composition comprising a hydrocarbon of claim 1 in admixture with further ingredients and additives.

15. A process for manufacturing a modified hydrocarbon as defined in claim 1, said process comprising the radical reaction of:
a branched saturated hydrocarbon (RₕH), wherein (Rₕ) is a branched saturated hydrocarbon chain containing at least 15 carbon atoms
with
a haloalkylene of formula (II)
CYX=CXY (II)
in which X is independently selected from:
hydrogen and
a halogen selected from fluorine and chlorine;
each Y is independently selected from:
hydrogen;
a halogen selected from fluorine and chlorine;
a group of formula R¹-L-, wherein R¹ is a straight or branched C₁-C₁₀ alkyl group, optionally fully or partially halogenated and optionally interrupted by one or more heteroatoms including N, O, S and P and -L- represents a covalent bond or a group selected from —NR²—, —O— and —S—, wherein R² is fully or partially halogenated C₁-C₃ alkyl; and
n is a number equal to or higher than 1,
with the proviso that at least one of X or Y is halogen
the reaction being initiated by contacting hydrocarbon (RₕH) and haloalkylene (II) with an organic or inorganic peroxide, with a redox system, with ozone or hydrogen peroxide.
